(19) United States
(12) Patent Application Publication
(10) Pub. No.: US 2021/0030018 A1
(43) Pub. Date: Feb. 4, 2021

(54) CONFECTIONERY COMPOSITIONS CONTAINING STEVIA LEAVES

(71) Applicant: WM. WRIGLEY JR. COMPANY, Chicago, IL (US)

(72) Inventors: Xiaoqun MO, Oak Park, IL (US); Chia-Hua HSU, Glenview, IL (US); Xiaohu XIA, Deerfield, IL (US)

(21) Appl. No.: 16/968,247

(22) PCT Filed: Feb. 13, 2019
(86) PCT No.: PCT/US19/17838

§ 371 Date: Aug. 7, 2020

Related U.S. Application Data
(60) Provisional application No. 62/630,343, filed on Feb. 14, 2018.

(51) Int. Cl. A23G 4/06; A23G 4/10; A23L 27/30; A23L 3/44; A23G 3/48; A23G 3/42

(52) U.S. Cl. CPC A23G 4/068; A23G 4/10; A23L 27/36; A23V 2002/00; A23G 3/48; A23G 3/42; A23L 3/44

(57) ABSTRACT

Confectionery compositions which comprise Stevia leaves for use in confectionery products are disclosed. In certain non-limiting embodiments of the disclosed formulations, the confectionery composition containing Stevia leaves exhibits little to no bitterness and a sugar-like taste.

### FIELD

The presently disclosed subject matter relates to enhanced sweetener formulations, particularly for use in confectionery products. Specifically, the present disclosure is directed to compositions that include Stevia leaves. The compositions can include combinations of compounds that can be used to enhance a sweetening attribute, such as duration of sweetness with reduced bitterness in an oral composition.

### BACKGROUND

Steviol glycosides are natural sweet constituents of Stevia rebaudiana Bertoni (Asteraceae), a plant that is widely cultivated in South America particularly in northeast Paraguay, Brazil, and Argentina. Stevia leaf contains nutritive ingredients including nine essential amino acids (glutamic acid, aspartic acid, lysine, serine, isoleucine, alanine, proline, tyrosine and methionine), six fatty acids (palmitic, palmitoleic, stearic, oleic, linoleic and linolenic acids), water-soluble vitamins (folic acid, vitamin C and vitamin B2), phytochemicals (austroinullin, β-carotene, dulcoside, nilacin, rebaudi oxides, riboflavin, steviol, stevioside and thiamine), secondary metabolites (tannins, alkaloids, cardiac glycosides, saponins, sterols and triterpenes, reducing compounds and anthraquinones), and minerals (calcium, phosphorous, sodium, potassium, iron, magnesium and zinc).

Stevia produces sweet glycosides, which all have the steviol backbone, commonly known as steviol glycosides. The primary steviol glycosides present in Stevia leaf are stevioside, rebaudioside (A to F), steviolbioside, and isosteviol. Among these, stevioside (4-13% w/w), rebaudioside A (2-4% w/w) and rebaudioside C (1-2% w/w) are the most abundant steviol glycosides present in the plant leaves. These complexes are concentrated in the leaves of Stevia and their amount depends on the plant genotype and environmental conditions. Steviol glycosides are the precursors of many natural high potency sweeteners. The glycosides are extracted from the leaves of the Stevia rebaudiana plant. The leaves of Stevia rebaudiana Bertoni have been used by the natives of Paraguay to sweeten beverages for centuries.

Rebaudioside A is described as 200 times sweeter than sugar. Steviol glycosides, unlike regular sugar, do not impact blood sugar when consumed. Accordingly, these compounds have found popularity as low carbohydrate alternatives and sugar substitutes in confectionery products such as chewing gum. These high potency sweeteners do not add calories to the final product, or cause tooth decay. Steviol glycosides are obtained by extraction from the Stevia rebaudiana plant, and then incorporated into various food products.

However, these steviol glycosides obtained through various extraction methods exhibit increased bitterness or a metallic taste when applied to food products. This increase in bitterness may be associated with a quicker decrease in sweetness, the extraction methods employed to isolate the glycosides, or because the glycosides are used alone or in varying combinations which provide bitterness. Thus, there is a need for improved Stevia sweetener compositions that can be incorporated into a confectionery product that include Stevia leaves having improved taste, reduced bitterness and stability over time. The presently disclosed subject matter addresses this problem.

### SUMMARY OF THE INVENTION

The presently disclosed subject matter is directed to a confectionery composition including ground Stevia leaves. It has been found that the addition of Stevia leaves to a confectionery composition such as chewing gum provides sweetness without the bitterness as when steviol glycosides or stevioside extracts are used.

In certain aspects, the present disclosure provides a confectionery composition, comprising Stevia leaves and at least one sweetener.

In certain embodiments, the confectionery composition is chewing gum or a chewy confection. In other embodiments, the confectionery composition is a fruit bar. The confectionery composition can include Stevia leaves in an amount of from about 0.5 wt % to about 10 wt %. For example, and not limitation, the confectionery composition can include Stevia leaves in an amount of from about 0.5 wt % to about 5.0 wt %. In certain embodiments, the Stevia leaves can be ground Stevia leaves. In certain embodiments, the confectionery composition can include a sweetener in an amount of from about 10 wt % to about 99 wt %. For example, and not limitation, the sweetener is present in an amount of from about 35 wt % to about 75 wt %. In other embodiments, the sweetener composition is present in the chewing gum in an amount of from about 0.001% to about 10% wt % or from about 0.01% to about 5% wt %.

In other embodiments, a confectionery composition comprises Stevia leaves and a nutritive sweetener selected from the group consisting of sucrose, dextrose, maltose, dextrin, dried invert sugar, fructose, galactose, corn syrup solids and the like, alone or in any combination.

In certain embodiments, the confectionery composition further comprises a non-nutritive sweetener selected from the group consisting of aspartame, neotame, advantame, sucralose, acesulfame potassium (Acek), sodium saccharin, glycyrrhizin, Neohysperidine Dihydrochalcone (NHDC), Neotame, Lou Han Guo, brazzein, monatin, thaumatin, alitame, saccharin and its salts, cyclamic acid and its salts, monellin, steviol glycosides such as Reb A, Reb B, Reb C, Reb D, Reb M combinations thereof.

Without being bound to any particular theory, Applicant believes that incorporating Stevia leaves into a chewing gum composition can also improve stability of the chewing gum composition by delaying gum oxidation. For example, chewing gum containing 1 wt % leaf reduces the rate of chewing gum oxidation, thereby reducing or eliminating the need for antioxidants in the chewing gum composition. In certain embodiments, the chewing gum composition comprising dried Stevia leaves contains about less than 1.0%, less than 0.05%, less than 0.01% or no synthetic antioxidants by weight of the chewing gum composition. The selected antioxidant may be selected from butylated hydroxyanisole, butylated hydroxytoluene, propyl gallate, octyl gallate, dodecyl gallate, ascorbyl palmitate, di-t-butylhydroquinone, or combinations thereof. In other embodiments, the chewing gum contains Stevia leaves are freeze dried. In another embodiment, the chewing gum contains about 0.05%, about 1.0%, about 1.5%, about 2.0%, or about 2.5% by weight dried Stevia leaves.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### BRIEF DESCRIPTION OF THE DRAWINGS

FIGS. 1a-1d provide graphical representations of attributes of sweetness, flavor intensity, bitterness, and off-tastes of chewing gum containing Stevia leaves at 1 wt %, 2.5 wt %, and 5 wt % by weight of the chewing gum.

FIG. 2 provides graphical representations of antioxidant effects of chewing gum containing Stevia leaves at 1 wt % by weight of the chewing gum. The accelerated oxidation test was run on RapidOxy from Anton Paar following ASTM D7525. The oxidation rate is represented by the oxygen pressure drop as a function of time.

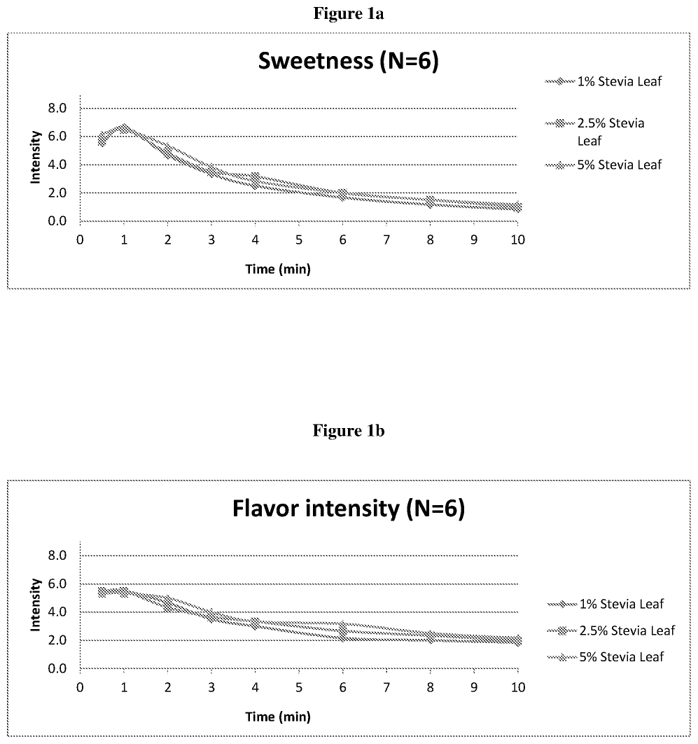

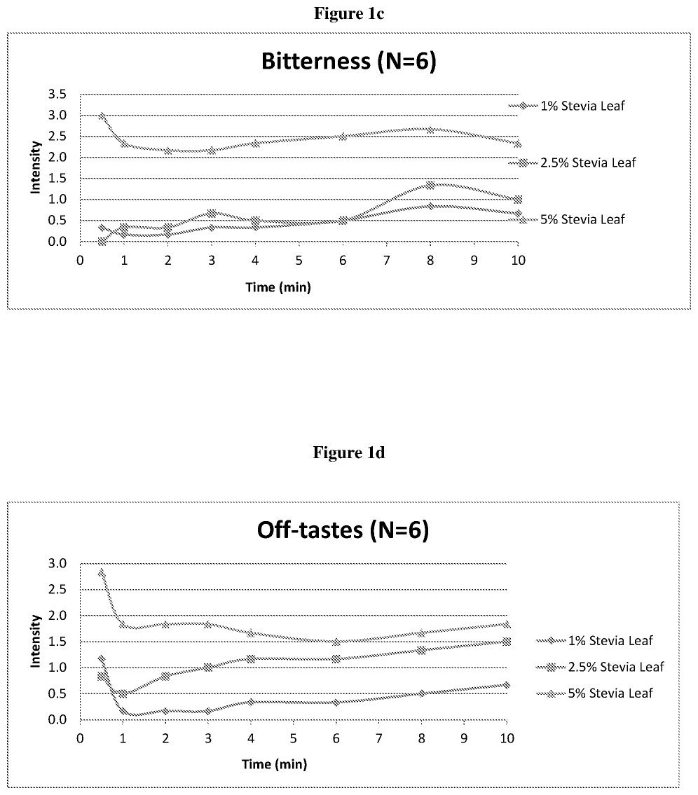

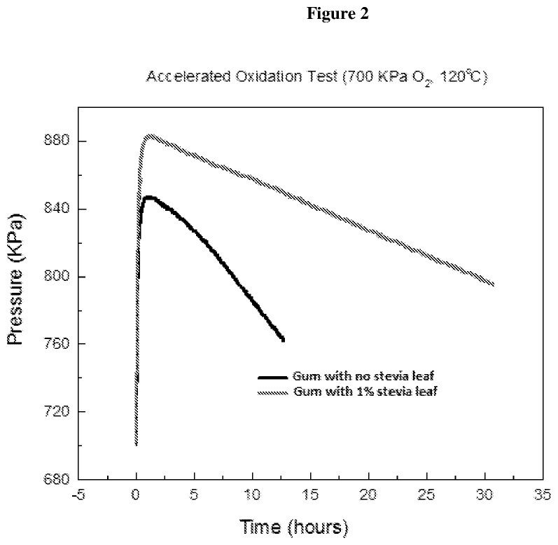

### DETAILED DESCRIPTION

As noted above, to date, there remains a need in the art for compositions that provide sweetening attributes to various confectionery products, without negative taste attributes, such as bitterness. The presently disclosed subject matter addresses this need through the use of Stevia leaves in confectionery compositions that have sweetness without an increase in bitterness.

### 1. Definitions

The terms used in this specification generally have their ordinary meanings in the art, within the context of this disclosed subject matter and in the specific context where each term is used. Certain terms are discussed below, or elsewhere in the specification, to provide additional guidance to the practitioner in describing the compositions and methods of the disclosed subject matter and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

As used herein, “food product” or “food product composition” includes ingestible products including but not limited to human foods, animal or pet foods, pharmaceutical products, and consumer products.

As used herein, the term “confectionery product” refers to a sweet or dessert edible composition. Confectionery products can include, but are not limited to, cakes, cookies, pies, candies (hard and soft), fruit bars, granola bars, compressed mints, chewing gums, gelatins, ice creams, sorbets, jams, jellies, chocolates, fudge, fondant, liquorice, taffy, and combinations thereof.

As used herein, the term “chewing gum” refers to a flavored substance intended for chewing. The term as used herein also includes bubble gum and confectionery products containing chewing gum. In certain embodiments, chewing gum forms include, but are not limited to, tablets, sticks, solid balls, hollow balls, cut and wrap, and pellets or pillows. Unless otherwise specified, all percentages used herein are weight percents. As used herein, chewing gum base contains a gum non-filler base portion and a gum base filler portion.

As used herein “admixing,” refers to the process where the sweetener formulation is mixed with or added to the completed product or mixed with some or all of the components of the product during product formation or some combination of these steps. When used in the context of admixing, the term “product” refers to the product or any of its components. This admixing step can include a process selected from the step of adding the sweetener formulation to the product, spraying the sweetener formulation on the product, coating the sweetener formulation on the product, suspending the sweetener formulation in the product, painting the sweetener formulation on the product, pasting the sweetener formulation on the product, encapsulating the product with the sweetener formulation, mixing the sweetener formulation with the product and any combination thereof. The sweetener formulation can be a liquid, dry powder, spray, paste, suspension and any combination thereof.

As used herein, the term “Stevia leaves” refers to leaf, stem, and other plant material from the above-ground parts of plants of Stevia rebaudiana Bertoni.

As used herein, “ground Stevia leaves” refers to Stevia leaves that have been dried in any suitable manner and processed into fine particles. The ground Stevia leaves may resemble a powder, or can be composed of larger, generally homogenous particles. For example, the Stevia leaves can be ground using a Turkish Grind for one or more repetitions. In certain embodiments, the ground Stevia leaves can be ground to an average particle size of from about 0.5 mm to about 1.0 mm, 1.0 mm to about 1.5 mm, and 1.5 mm to about 2 mm, or combinations thereof. In an alternative embodiment, the Stevia leaves have a particle size of less than 0.5 mm. In yet another embodiment, the Stevia leaves have a particle size of about 0.01-0.5 mm, of about 0.01 to 0.03 mm, or from about 0.03-0.15 mm. In a preferred embodiment, very fine particles of about 0.01-0.03 mm could be used for color applications.

As used herein, “coarse Stevia leaves” refers to Stevia leaves that have not been processed to reduce size, or which have been processed into larger flakes. For example, the coarse Stevia leaves can be prepared by chopping, dicing, hashing, breaking, or otherwise fracturing Stevia leaves into smaller fragments. The coarse Stevia leaves can have generally homogenous particle sizes, or can have varied particle sizes. The particles sizes of coarse Stevia leaves will generally be larger than those of ground Stevia leaves. In certain embodiments, the coarse Stevia leaves can have an average particle size of from about 2.0 mm to about 5.0 mm, 5.0 mm to about 10.0 mm, 10.0 mm to about 15.0 mm, 15.0 mm to about 20.0 mm, 20.0 mm to about 25.0 mm, 25.0 mm to about 30.0 mm. As used herein, “large leaf Stevia leaves” can be considered a type of coarse Stevia leaves.

As used herein, a “sweetener” refers to bulk sweeteners and high potency sweeteners. Sweeteners may be nutritive or non-nutritive.

As used herein, a “high potency sweetener” refers to sweeteners that have a sweetness intensity at least 30 times greater than that of sucrose.

As used herein, a “bulk sweetener” refers to sweeteners that can give “bulk” or texture to foods, especially in confectionery and chewing gum. The main class of compounds used as bulk sweeteners are sugars (e.g., sucrose, lactose) and sugar alcohols (e.g. sorbitol, mannitol, xylitol) and these provide 2.4 kcal/g (compared with 4 kcal/g for sucrose). Other bulk sweeteners may also be employed, including but not limiting to tagatose, polysaccharides, and fibers.

### 2. Confectionery Compositions

The confectionery compositions of the presently disclosed subject matter can be used in various edible compositions, including confectionery products such as chewing gums and chewy candies. In certain embodiments, the Stevia leaves impart sweetness, with little to no bitterness to the confectionery composition. In certain embodiments of the present application, the Stevia leaves are added to a confectionery composition in an amount effective to provide the desired sweetness.

In certain embodiments, Stevia leaves of the presently disclosed subject matter can be incorporated into confectionery compositions including, but not limited to, cakes, cookies, pies, candies (hard and soft), compressed mints, chewing gums, gelatins, ice creams, sorbets, jams, jellies, chocolates, fudge, fondant, liquorice, taffy, and combinations thereof.

### 2.1 Chewing Gums

Preferably, the flavor compositions of the presently disclosed subject matter are incorporated into a chewing gum. In certain embodiments, the chewing gum can be in the form of tablets, sticks, solid balls, hollow balls, cut and wrap, and pellets or pillows. Suitable processes for making chewing gum and additional components that may be incorporated into chewing gum are described by way of example in U.S. Pat. No. 8,557,323; U.S. Publication Nos. 2013/0156885 and 2005/0202118, each of which is incorporated by reference in its entirety herein.

In general, a chewing gum composition typically contains a chewable gum base portion which is essentially free of water and is water-insoluble, a water-soluble bulk portion, and flavors which are typically water insoluble, such as the presently disclosed flavor compositions. The water-soluble portion dissipates with a portion of the flavor over a period of time during chewing. The gum base portion is retained in the mouth throughout the chew.

The insoluble gum base generally comprises any combination of elastomers, elastomer solvents, plasticizers, waxes, emulsifiers, tackifiers, lipids, fillers, including inorganic fillers, and other optional ingredients such as colorants and antioxidants. Plastic polymers, such as polyvinyl acetate, which behave somewhat as plasticizers, can also be included. Other plastic polymers that may be used include polyvinyl laureate, polyvinyl alcohol and polyvinyl pyrrolidone. As embodied herein, the insoluble gum base can constitute between about 5 wt-% to about 95 wt-% of the chewing gum. More preferably the insoluble gum base comprises between about 10 wt-% and about 50 wt-% of the gum and most preferably between about 20 wt-% and about 35 wt-% of the gum.

Elastomers may include polyisobutylene, butyl rubber, (isobutylene-isoprene copolymer), polyisoprene, polyvinyl acetate, styrene butadiene rubber, vinyl acetate-vinyl laurate copolymer, poly-dl-lactide, glycolic acid-lactide copolymer and styrene butadiene rubber. The elastomer can include one or more natural elastomers, for example, natural rubber such as smoked or liquid latex and guayule, as well as natural gums such as jelutong, lechi caspi, perillo, massaranduba balata, massaranduba chocolate, nispero, rosindinha, chicle, gutta hang kang or mixtures thereof. Elastomer solvents are often resins such as terpene resins and rosin esters.

Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

Tackifiers, if present, can include natural rosin esters such as glycerol ester of partially hydrogenated rosin, glycerol ester of polymerized rosin, glycerol ester of partially dimerized rosin, glycerol ester of rosin, pentaerythritol esters of partially hydrogenated rosin, methyl and partially hydrogenated methyl esters of rosin, pentaerythritol ester of rosin or mixtures; synthetic resins such as terpene resins derived from alpha-pinene, beta-pinene and/or d-limonene, polyvinyl acetate resin, polyethylene, and poly-dl-lactide resin.

Lipids, if present, can include mono-, and/or di-, and/or tri-glycerides of alkanoic acids, or of monoenoic acids or of polyunsaturated fatty acids with carbon chain length from C4 to C24 or a mixture thereof, hydrogenated and partially hydrogenated mono-, and/or di-, and/or tri-glycerides of monoenoic acid and of polyunsaturated fatty acids, acetylated glycerides of fatty acids, lecithin, paraffin wax, and microcrystalline and natural waxes such as beeswax and carnauba.

The gum base typically also includes a filler component. The filler component may be calcium carbonate, magnesium carbonate, talc, dicalcium phosphate or the like. The filler may constitute between about 5 wt % and about 60 wt % of the gum base. Preferably the filler comprises from about 5 wt % to about 50 wt % of the gum base. In certain embodiments, fillers include, but are not limited to, magnesium and calcium carbonate, ground limestone and silicate types such as magnesium and aluminum silicate, clay, alumina, talc as well as titanium oxide, mono-, di- and tricalcium phosphate, cellulose polymers such as ethyl, methyl and wood or mixtures thereof, and combinations thereof.

Gum bases can also contain softeners including glycerin, lecithin, glycerol monostearate and glycerol triacetate. In certain embodiments, humectants are added to the chewing gum in order to optimize the chewability and mouth feel of the gum. Further, aqueous sweetener solutions such as those containing sorbitol, hydrogenated starch hydrolysates, corn syrup and combinations thereof can be used as softeners and binding agents in chewing gum formulations. Gum bases can also contain optional ingredients such as antioxidants, colors, and emulsifiers. The present invention contemplates employing any commercially acceptable gum base.

The water-soluble portion of the chewing gum can comprise softeners, sweeteners, flavoring agents (including sensates such as physiological cooling agents, warming agents and tingling agents), high-intensity sweeteners, colorants, humectants, gum emulsifiers, acidulants, binders, fillers, cooling agents and combinations thereof. The sweeteners often fulfill the role of bulking agents in the gum. Bulk sweeteners can include both sugars and sugar alcohols. The bulking agents typically comprise about 5% to about 95% of the gum composition.

The Stevia leaves of present invention can be used in sugar and sugarless gum formulations. Sugar sweeteners generally include saccharide-containing components commonly known in the chewing gum art which comprise, but are not limited to, sucrose, dextrose, maltose, dextrin, allose, isomaltulose, dried invert sugar, fructose, galactose, corn syrup solids and the like, alone or in any combination. Sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination.

In some embodiments, the chewing gum ingredients can include one or more high intensity sweeteners. As used herein, the term “high intensity sweetener” refers to any substance that is at least twenty times sweeter than sucrose. Such sweeteners include, but are not limited to, saccharin, cyclamate, aspartame, alitame, neotame, lou han guo, barzzein, monatin, thaumatin, monellin, peptide-based sweeteners, sucralose, acesulfame K, Stevia glycosides (including purified Stevia extracts such as rebaudioside A rebaudioside D, rebaudioside M), glycyrrhizin, neohesperidin dihydrochalcone and mixtures thereof. In some embodiments, at least a portion of the high intensity sweetener will be encapsulated. Such encapsulations may be produced by granulation, agglomeration, extrusion and grinding, spray drying, fluid bed encapsulation or any other known means. In certain embodiments, suitable sugar alcohols include sorbitol, mannitol, xylitol, hydrogenated starch hydrolysates, maltitol, and the like, as well as combinations thereof. In certain embodiments, the sugarless gum comprises a combination of a high-potency sweetener with a sugar alcohol, e.g., aspartame and sorbitol. Usage levels will depend on the potency of the sweetener, degree and effectiveness of the encapsulation (if any) as well as the sensory profile desired for the product. Generally, the sweetener can be used at levels as low as 0.005 wt %, or as low as 0.05 wt %, or as low as 0.2 wt %, to as high as 5 wt %, or as high as 3 wt %, or as high as 2 wt % in the chewing gum composition. In some embodiments, the high intensity sweetener will be present at a level of from about 0.1 wt % to about 1.0 wt % of the chewing gum ingredients.

In certain embodiments, the presently disclosed flavor composition comprising mint leaves and mint flavor can be added to the chewing gum in amounts of from about 0.01 wt % to about 20 wt % of the gum, or from about 0.05 wt % to about 10 wt % of the gum, or from about 0.1 w % to about 5 wt % of the gum, and preferably, from about 0.2 wt % to about 10 wt % by weight, or from about 0.5 wt % to about 7 wt % of the total weight of the chewing gum.

In certain embodiments, a variety of additional flavoring agents can also be used, if desired. Flavoring agents may include essential oils, synthetic flavors or mixtures thereof including, but not limited to, oils derived from plants and fruits such as citrus oils, fruit essences, clove oil, anise, and the like. Artificial flavoring agents and components may also be used. Natural and artificial flavoring agents may be combined in any sensorially acceptable fashion. Included in the general category of flavors are sensates, chemicals which impart physiological sensations in the mouth such as cooling agents, warming agents and tingling agents. Examples of cooling agents include menthol, WS-23, WS-3, WS-5, isopulegol, esters of menthol such as menthyl succinate, menthyl lactate and menthyl glutarate, among others. Warming and tingling agents include capsaicin, piperine, jambu and spilanthol.

Optional ingredients such as colorants, whiteners, antioxidants, emulsifiers and pharmaceutical agents may also be added as separate components of the chewing gum composition, or added as part of the gum base. In certain embodiments, the colors and whiteners can include, but are not limited to, FD&C-type dyes and lakes, fruit and vegetable extracts, titanium dioxide or mixtures thereof. In certain embodiments, the antioxidants can include, but are not limited to, beta-carotenes, acidulants (e.g. Vitamin C), alpha-tocopherol (vitamin E), beta, gamma and delta tocopherols, propyl gallate, butylated hydroxyanisole (BHA), butylated hydroxytoluene (BHT) and tertiary butyl hydroquinone (TBHQ). In specific embodiments, the gum base includes optional minor amounts (about one percent or less) of miscellaneous ingredients such as colorants, antioxidants, etc.

### 2.1.1 Methods of Making

As embodied herein, a method of manufacturing chewing gum according to the present disclosure is by sequentially adding the various chewing gum ingredients to any commercially available mixer known in the art. After the ingredients have been thoroughly mixed, the gum is discharged from the mixer and shaped into the desired form such as by rolling into sheets and cutting into sticks, extruding into chunks, or casting into pellets.

Generally, the ingredients are mixed by first melting the gum base and adding it to the running mixer. The base may also be melted in the mixer itself. Color or emulsifiers may also be added at this time, along with syrup and a portion of the bulking agent. Further portions of the bulking agent may then be added to the mixer. A flavoring agent can be added with the final portion of the bulking agent. The flavor composition can then be added. The entire mixing procedure typically takes from five to twenty minutes, but longer mixing times may sometimes be required. Those skilled in the art will recognize that many variations of the above described procedures may be followed.

In certain embodiments, the Stevia leaves can be pre-blended prior to addition to the chewing gum mixture. For example, the Stevia leaves and flavor, along with additional components, if any, in the flavor composition can be mixed together before being added to the chewing gum mixture. In certain embodiments, the Stevia leaves can be pre-mixed with a bulk sweetener aged prior to being added to the chewing gum mixture. In another embodiment, the Stevia leaves can be air-dried for at least 1 day, at least 5 days, at least 7 days, at least 10 days, at least 14 days, or longer. Additionally or alternatively, the Stevia leaves can be treated with heat or freeze-dried prior to incorporation into the chewing gum. In other embodiments, the air-dried leaves that are added to the chewing gum have a moisture content of about less than 10%, less than 5%, and less than 1%.

As embodied herein, if formed into pellets or balls, the chewing gum composition can be coated. The coating is initially present as a liquid syrup which contains from about 30% to about 80% or 85% sugars or sugar alcohols, and from about 15% or 20% to about 70% of a solvent such as water. In general, the coating process is carried out in conventional panning equipment. Gum center tablets to be coated are placed into the panning equipment to form a moving mass.

The material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the panning procedure, syrup is added to the gum center tablets at a temperature range of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In another embodiment, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to about 60 coats are applied. In any event, the present invention contemplates applying an amount of syrup sufficient to yield a coated chewing gum product containing about 10% to about 65% coating. Preferably, the final product will contain from about 20% to about 50% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

Once a coating of syrup is applied to the gum center, the syrup is dried in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8 percent.

The drying air may be passed over and admixed with the syrup coated gum centers in any way commonly known in the art. Preferably, the drying air is blown over and around the syrup coated gum center. If a flavor is applied after a syrup coating has been dried, the present invention contemplates drying the flavor with or without the use of a drying medium.

In certain embodiments, upon manufacturing the chewing gum, the chewing gum is maintained in a low moisture and/or low light environment. In certain embodiments, the water activity of the chewing gum is maintained below about 0.85. In certain embodiments, the water activity can be mitigated by using a low amount of glycerol in the chewing gum. For example, and not limitation, in certain embodiments the chewing gum can include from about 0.25 wt % to about 1 wt %, and preferably from about 0.5 wt % to about 0.7 wt % glycerol. In certain embodiments, the amount of glycerol can be further reduced by including additional syrup and/or sweetener components. Additionally or alternatively, the chewing gum can be appropriately packaged as known in the art to reduce exposure to moisture and/or light. As embodied herein, reducing exposure to moisture and/or light can improve the flavor and color stability of the chewing gum, and increase the shelf life of the chewing gum.

### 2.2 Chewy Confections

Chewy candies are opaque and generally firm, having an elastic texture that appeals to consumers. As a chewy confection is chewed, it does not break apart, but dissolves slowly in the mouth. These smaller confection pieces deliver flavor and sweetness as they dissolve into a pliable chewy substance in the mouth. Chewy confection is a food product that is formed by a) mixing a sweetener solution (generally sugar and corn syrup), (b) creating a hydrated suspension containing water and a gelling agent, (c) combining the sweetener solution and gelling agent, (d) then adding a fat mixture after whipping the sweetener mixture and gelling agent together and aerating the formed product by forming the mass into a finished piece.

Traditional chewy confectionery products are typically made with a sweetener bulking agent and a texturizing agent. Commonly used sweeteners are sucrose and glucose syrup or corn syrup. A fat is also commonly added to such chewy confectionery products to achieve desired chew characteristics. Chewy confectionery products have a cohesive nature under normal room conditions. Chewy confectionery product may further include water, foaming agents, humectants, artificial and natural sweeteners, emulsifiers, flavor enhancers, acids, essential oil, artificial and natural flavorings, colorings, fruit juices, vegetable juices, proteins, and other additives typically used in the production of chewy confectionery products as desired. Often times chewy confectionery products are referred to as chewy candy, toffee, gummies, or taffy.

Traditional chewy confections products typically contain gelatin, starch, egg white (albumin), or combinations thereof as the texturing agent so that they have the chewy texture that is desirable for the products. Gelatin is the most popular of the texturizing agents as it gives the chewy confectionery products a long lasting cohesive chew; however, there are also several downfalls to using gelatin in confectionery products. Food grade gelatin is obtained from bovine or porcine raw materials and is thus undesirable to a number of groups who observe certain dietary restrictions. Additionally, since gelatin is a protein it is highly sensitive to temperature and/or acid which may cause it to degrade and foul.

Each texturizing agent has its own advantages. One of the advantages of using starch as the texturizing agent in such products is that it allows one to control the viscosity of the substance during production, which helps with control of subsequent cold flow during storage. The advantage of using gelatin as the texturizing agent in chewy confectionery products is that the gelatin gives the candy a distinctive chewy texture that ranges from soft to very firm depending on the amount of gelatin used. Using egg white as the texturizing agent helps stabilize incorporated air thus keeping air bubbles from collapsing—this gives the product a light and airy texture.

Use of egg white and gelatin as texturizing agents is not desirable in the confectionery industry as both are animal derived ingredients. Additionally, since gelatin and egg white are proteins they are sensitive to temperature and/or acid which may cause them to degrade or foul. Use of starch, on the other hand, eliminates the use of animal products in the chewy confectionery product, but it tends to have a low gelling tendency and is not as useful alone in creating the ideal chewy texture in a chewy confectionery product thus gelatin is most often added to achieve the desired chew characteristics and texture. Gelatin tends to add a bouncy, rubbery texture.

A variety of sweetener bulking agents can also be used besides sucrose. Other sugars that can be used are dextrose, maltose, lactose, galactose, tagatose, allose, isomaltulose, various types of glucose syrups such as corn, rice, high fructose, and allulose syrups. For a low-calorie product, alditols or polyols may be used such as sorbitol, mannitol, maltitol, isomalt, erythritol, and various types of hydrogenated starch hydrolyzates (HSH). The sweetener may be added to the chewy confectionery product in the amount of about 10-99% by weight of the chewy confectionery product. Fats may be added to the chewy confectionery product in the amount of about 0.5-25% by weight of the chewy confectionery product.

For a low-calorie product, alditols or polyols may be used such as sorbitol, mannitol, maltitol, isomalt, erythritol, and various types of hydrogenated starch hydrolyzates (HSH). The sweetener may be added to the chewy confectionery product in the amount of about 10-99% by weight, and the allulose may be added in the amount of about 10-90% by weight of the chewy confectionery product. Fats may be added to the chewy confectionery product in the amount of about 0.5-25% by weight of the chewy confectionery product.

### 3. Stevia Leaves

The presently disclosed confectionery compositions include Stevia leaves. The Stevia leaves can be from a single type of Stevia plant, or can be a combination of two or more types of plants. For purpose of example, and not limitation, suitable types of Stevia plants from the genus S. rebaudiana. In particular embodiments, the Stevia leaves are from a Bertoni plant.

In certain embodiments, the Stevia leaves can be dried. In certain embodiments, the Stevia leaves are freeze dried. In other embodiments, the Stevia leaves are oven-dried, drum-dried, or any other drying process. In a preferred embodiment, the Stevia leaves are dried by freeze-drying, microware drying, infrared drying, and radio-frequency drying. In another preferred embodiment, the Stevia leaves are dried to have a moisture content of about less than 10%, about less than 5%, or about less than 1%.

The Stevia leaves can be incorporated into the confectionery composition in any form, including large leaf, coarse, or ground. In certain embodiments, dried Stevia leaves are ground prior to incorporation into the flavor composition. In other embodiments, the Stevia leaves are ground prior to incorporation into the bulk sweetener. In certain embodiments, dried Stevia leaves are ground to an average particle size of less than 3 mm, or less than 2 mm prior to incorporation into a chewing gum base. In certain embodiments, dried Stevia leaves are ground to an average particle size of from about 1 mm to about 2 mm prior to incorporation into the molten chewing gum composition. In certain embodiments, the ground Stevia leaves can be ground to an average particle size of from about 0.5 mm to about 1.0 mm, 1.0 mm to about 1.5 mm, and 1.5 mm to about 2 mm, or combinations thereof. In an alternative embodiment, the Stevia leaves have a particle size of less than 0.5 mm. In yet another embodiment, the Stevia leaves have a particle size of about 0.01 mm-0.5 mm, of about 0.01 mm to 0.03 mm, or from about 0.03 mm-0.15 mm. In a preferred embodiment, very fine particles of about 0.01 mm-0.03 mm could be used for color applications.

As embodied herein, the Stevia leaves can be present in the confectionery composition in an amount of less than 90 wt %, less than 75 wt %, less than 60 wt %, less than 50 wt %, less than 40 wt %, less than 30 wt %, less than 20 wt %, or less than 10 wt %. In certain embodiments, the Stevia leaves can be present in the confectionery composition in an amount of from about 1 wt % to about 90 wt %, or from about 15 wt % to about 80 wt %, or from about 20 wt % to about 70 wt %, or from about 25 wt % to about 60 wt %.

### 3.1 Additional Sweeteners

The present application relates to confectionery compositions containing Stevia leaves that may include at least one, two, three, or more sweetener compounds. In certain embodiments, the sweetener can be used as a bulk sweetening agent, or as a high potency sweetener. In another embodiment, the sweetener is used to increase the longevity of a sweetening attribute of an edible composition, such as chewing gum. In further embodiments, the sweetener provides a long-lasting sweetening sensory attribute without increasing a bitter taste or metallic taste in the chewing gum composition. In certain embodiments, the sweetener is encapsulated.

In yet other non-limiting embodiments, the confectionery compositions can further comprise one, two, three, four, five or more sweetener compounds, for example, aspartame, neotame, advantame, sucralose, acesulfame potassium (Ace-k), sodium saccharin, glycyrrhizin, neohysperidine dihydrochalcone (NHDC), lou han guo, brazzein, monatin, thaumatin, alitame, saccharin and its salts, cyclamic acid and its salts, monellin and combinations thereof. In certain embodiments, the sweetener formulation comprises at least one steviol glycoside. In certain embodiments, the sweetener formulation comprises Reb A. Sweetener compounds generally release quickly from chewing gum during mastication. In certain embodiments, the chewing gum formation process can include modification of one or more sweetener compounds by encapsulation or agglomeration before addition to the chewing gum formulation to delay the release of sweetener.

In other embodiments, sweetener compounds may be coated by an encapsulating agent applied by spray drying, fluid bed coating, fiber spinning or coacervation techniques, agglomeration, and fixation or entrapment/absorption, extrusion, plus additional encapsulation or agglomeration.

In certain embodiments, encapsulation modifies the release of sweetener formulations from the chewing gum by modifying the solubility or dissolution rate. Any standard technique which gives partial or full encapsulation of the combination of sweetener formulations can be used. In certain embodiments of the presently disclosed subject matter, encapsulation techniques include, but are not limited to, spray drying, fiber spinning, agglomeration, spray chilling, fluid-bed coating, extrusion, fixation or entrapment/absorption and coacervation. In certain embodiments, encapsulation techniques that give partial encapsulation or full encapsulation can be used.

In certain embodiments, suitable encapsulating materials can include, but are not limited to, water-soluble sugar or sugar alcohol such as sorbitol, isomalt, dextrose, erythritol, lactitol, maltitol, mannitol, xylitol, hydrogenated corn syrup and mixtures thereof. In certain embodiments, encapsulating materials can also include polysaccharides such as starch, modified starch, hydroxyl methyl cellulose, hydroxypropyl methylcellulose (HPMC), sodium alginate, alpha, beta and gamma cyclodextrin.

In certain embodiments, suitable encapsulants for use in delayed release of sweetener compounds include, but are not limited to, polyvinyl acetate, polyethylene, crosslinked polyvinyl pyrrolidone, polymethylmethacrylate, polyacetic acid, polyhydroxyalkanoates, ethylcellulose, polyvinylacetate phthalate, methacrylic acid-co-methylmethacrylate and combinations thereof. In other embodiments, encapsulants for use in delayed release embodiments include, but are not limited to, polysacharrides and modified polysaccharides. Suitable polysaccharides can be sourced from botanical, algal, microbial and animals. Non-limiting examples of botanical derived polysaccharides include cellulose; tree gum extrudates such as gum arabic, gum karaya, gum ghatti, gum tragacanth and mesquite gum; plant derived polysaccharides such as pectin, arabinoxylan, xyloglucan, arabinogalactan, xylan, arabinan, and cellulose; seed derived polysaccharides such as guar gum, locust bean gum, tara gum, tamarind gum, xyloglucan, arabinoxylan and cereal β-glucan; and tuber derived gum such as konjac mannan. Non-limiting examples of algal derived polysaccharides include agar, carrageenan, furcellaran and alginate. Non-limiting examples of microbial fermentation product polysaccharides include xanthan gum, curdlan, dextran, gellan gum, pullulan, scleroglucan, alternan, elsinan and levan. Non-limiting examples of polysaccharides from animal sources include chitin and chitosan. Non-limiting examples of modified polysacharrides include substituted starch (starch acetate, octenyl succinyl starch), modified such as methyl cellulose and hydroxypropyl methylcellulose. Other suitable encapsulants for use in delayed release embodiments include, but are not limited to, proteins such as gelatin, zein, casein, soybean proteins, pea protein, whey protein and combinations thereof.

### 4. Additional Compounds

In certain embodiments of the disclosed subject matter, the flavor compositions can further include one or more additional compounds. For example, in certain embodiments, the flavor compositions can further include magnolia bark extract. As embodied herein, and without limitation, the magnolia bark extract can be present in the flavor composition in an amount of less than 25 wt %, less than 10 wt %, less 5 wt %, less than 3 wt %, or less than 2 wt %. For example, and without limitation, the ratio between the amount of magnolia bark extract and the amount of mint leaves in the flavor composition can range from about 0.01:1 to about 1:1, or from about 0.015:1 to about 0.5:1, or from about 0.02:1 to about 0.1:1, or from about 0.025:1 to 0.05:1, or from about 0.03:1 to about 0.04:1.

In certain non-limiting embodiments, additional compounds include, but are not limited to, cooling compounds and other chemicals that add additional flavor characteristics. The flavoring agent can be used in liquid or solid form. Flavoring agents may include artificial or natural flavors known in the art, for example synthetic flavor oils, natural flavoring aromatics and/or oils, oleoresins, extracts derived from plants, leaves, flowers, fruits, fruit flavors, and the like, or a combination thereof. Non-limiting representative flavors include oils such as cinnamon oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof.

Artificial flavor components are also contemplated by the present invention. Those of ordinary skill in the art will recognize that natural and artificial flavors may be combined in any sensorially acceptable blend. All such flavors and blends are contemplated by the presently disclosed subject matter.

### EXAMPLES

The presently disclosed subject matter will be better understood by reference to the following Examples, which are provided as exemplary of the disclosed subject matter, and not by way of limitation.

### Example 1: Stevia Leaves in Chewing Gum

The Stevia leaf was collected from Stevia plant. The leaves were washed and freeze-dried to remove water. Then ground to powder pass through No. 40 meshes. The grounded powder was added to gum at 1%, 2.5%, and 5% by weight of the chewing gum.

Sensory analysis was conducted on each gum sample reflected in Table 1 below. Six (6) sensory trained panelists evaluated the chewing gum samples made with 1%, 2.5%, and 5% freeze dried Stevia leaves at 0.5, 1, 2, 3, 4, 6, 8, 10 minutes. The chewing gum containing 1% Stevia leaf gave the best sensory profiles. The chewing gum with 5% Stevia leaf gave high bitterness and off-tastes described as bitter, metallic, astringent, soapy, and chalky; the gum cud also became mealy.

TABLE 1
Percentage by weight.

| Description | 1% Stevia leaf | 2.5% Stevia leaf | 5% Stevia leaf |
|---|---|---|---|
| Sorbitol | 55.05 | 53.55 | 51.05 |
| Base | 25.78 | 25.78 | 25.78 |
| Glycerin | 16.25 | 16.25 | 16.25 |
| Lecithin | 0.13 | 0.13 | 0.13 |
| Flavor | 1.86 | 1.86 | 1.86 |
| Stevia leaf | 1.00 | 2.5 | 5.0 |
| Total | 100.00 | 100.00 | 100.00 |

### Example 2: Freeze Dried Stevia Leaves in Chewing Gum

In this example, chewing gums were made with: 1) commercially available Stevia powder and 2) freeze dried Stevia leaf. Each chewing gum sample was evaluated by six (6) sensory trained panelists. Five of the six panelists rated the chewing gum containing the freeze-dried Stevia leaf taste better. The commercial Stevia leaf powder was found to be astringent. Without being held to any particular theory, Applicant theorizes that this could be due to the production of the commercial powdered material. It is believed that commercially available Stevia powders are derived from Stevia leaves that are dried under direct sunlight; this processing takes a longer period of time to dry, which could cause the Stevia composition to change, or oxidize, resulting in degradation of Stevia in the leaf, thereby creating unpleasant tastes such as bitterness and astringency.

Two chewing gum formulations were prepared by standard mixing procedures known in the art. The chewing gum formulations are summarized in Table 2.

TABLE 2
Chewing gums made with stevia powder and freeze
dried stevia leaf. Percentage by Weight

| | 1% Commercial Stevia | |
|---|---|---|
| Description | powder | 1% Freeze dried stevia leaf |
| Sorbitol | 55.05 | 55.05 |
| Base | 25.72 | 25.72 |
| Glycerin | 16.25 | 16.25 |
| Lecithin | 0.13 | 0.13 |
| Flavor | 1.86 | 1.86 |
| Stevia leaf | 1.00 | — |
| Stevia powder | — | 1.00 |
| Total | 100.00 | 100.00 |

TABLE 3
Chewy confectionery compositions containing
stevia leaves. Percentage by weight.

| | A | B | C |
|---|---|---|---|
| Gelatin | 1.9 | 1.9 | 1.9 |
| Gum Arabic | 0.2 | 0.2 | 0.2 |
| Water | 8.0 | 8.0 | 8.0 |
| Corn Syrup | 39.9 | 39.9 | 39.9 |
| Polyol | 39.9 | 20.0 | 20.0 |
| Sucrose | 0.0 | 19.9 | 10.0 |
| Dextrose | 0.0 | 0.0 | 5.0 |
| Trehalose | 0.0 | 0.0 | 4.9 |
| Palm Kernel Oil | 6.3 | 6.3 | 6.3 |
| Emulsifiers | 0.1 | 0.1 | 0.1 |
| Acids | 0.5 | 0.5 | 0.5 |
| 4:1 Fondant | 3.0 | 3.0 | 3.0 |
| Flavor | 0.2 | 0.2 | 0.2 |
| Powdered stevia leaf | 0.0-5.0% | 0.0-5.0% | 0.0-5.0% |
| Dried stevia leaf | 0.0-5.0% | 0.0-5.0% | 0.0-5.0% |
| TOTAL | 100.0% | 100.0% | 100.0% |

TABLE 4
Chewing gum containing 1% ground stevia leaves demonstrated
a reduction in the rate of oxidation than with chewing gum
containing no ground stevia leaves. Percentage by weight.

| | No stevia leaf | 1% Stevia leaf |
|---|---|---|
| Sorbitol | 56.05 | 55.05 |
| Base | 25.72 | 25.72 |
| Glycerin | 16.25 | 16.25 |
| Lecithin | 0.13 | 0.13 |
| Flavor | 1.86 | 1.86 |
| Stevia leaf | — | 1.0 |
| Total | 100.00 | 100.00 |

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, means, methods, or steps.

Patents, patent applications, publications, product descriptions, and protocols are cited throughout this application the disclosures of which are incorporated herein by reference in their entireties for all purposes.

What is claimed is:

1. A confectionery composition comprising Stevia leaves, wherein the Stevia leaves are present in an amount of from about 0.5% to about 5.0% by weight of the confectionery composition.

2. The confectionery composition of claim 1, wherein the Stevia leaves are present in an amount of from about 1.0% to about 2.5% by weight of the confectionery composition.

3. The confectionery composition of claim 1, wherein the Stevia leaves are ground Stevia leaves.

4. The confectionery composition of claim 1, further comprising a sweetener selected from the group consisting of aspartame, neotame, advantame, sucralose, acesulfame potassium, sodium saccharin, glycyrrhizin, neohysperidine dihydrochalcone, neotame, luo han guo, brazzein, monatin, thaumatin, alitame, saccharin and its salts, cyclamic acid and its salts, monellin, and combinations thereof.

5. The confectionery composition of claim 1, wherein the confectionery is chewing gum.

6. The confectionery composition of claim 1, wherein the confectionery is a chewy confection.

7. The confectionery composition of claim 1, wherein the Stevia leaves are freeze dried.

8. The confectionery composition of claim 1, wherein the Stevia leaves have an average particle size of from about 0.5 mm to about 2 mm.

9. The confectionery composition of claim 1, wherein the Stevia leaves have an average particle size of from about 0.01-0.5 mm.

10. The confectionery composition of claim 1, wherein the Stevia leaves have an average particle size of from about 0.03-0.15 mm.

11. A method of making the chewing gum comprising:
(a) blending ground Stevia leaves and the flavor to form a mixture; and
(b) thereafter, incorporating the mixture composition with a gum base and bulking agent to form the chewing gum.

12. The method of claim 11, wherein the ground Stevia leaves are dried at 37° C. for at least 1 day prior to blending.

13. The method of claim 11, wherein the ground Stevia leaves are dried by microwave drying, infrared drying, radio-frequency drying, or combinations thereof.

14. The method of claim 11, wherein the ground Stevia leaves are dried by freeze-drying.

15. The method of claim 11, the ground Stevia leaves are maintained at a temperature of from about 40° C. to about 60° C. for from about 15 minutes to 1 hour prior to blending.

16. A chewing gum composition comprising dried Stevia leaves wherein the chewing gum contains less than 1.0% by weight of a synthetic antioxidant selected from butylated hydroxyanisole, butylated hydroxytoluene, propyl gallate, octyl gallate, dodecyl gallate, ascorbyl palmitate, di-t-butylhydroquinone, or combinations thereof.

17. The chewing gum composition of claim 16, wherein the chewing gum contains less than 0.05% by weight synthetic antioxidant.

18. The chewing gum composition of claim 16, wherein the chewing gum contains no synthetic antioxidants.

19. The chewing gum composition of claim 16, wherein the dried Stevia leaves are freeze dried.

20. The chewing gum composition of claim 16, wherein the chewing gum contains about 1.0% by weight dried Stevia leaves.
